(19) United States
(12) Patent Application Publication
(10) Pub. No.: US 2010/0180682 A1
(43) Pub. Date: Jul. 22, 2010

(54) Accelerometer Switch and Associated Method

(76) Inventor: Arnold Darryl Bard, Long Branch, NJ (US)

Correspondence Address: Brandon L. Underwood, LLC, 44 Princeton Avenue, Brick, NJ, 08724, US

(21) Appl. No.: 12/685,625

(22) Filed: Jan. 11, 2010

Related U.S. Application Data
(60) Provisional application No. 61/146,291, filed on Jan. 21, 2009.

(51) Int. Cl. G01P 15/00

(52) U.S. Cl. 73/514.38

(57) ABSTRACT

In various embodiments, an accelerometer apparatus includes a center member; a resilient member, enclosing the center member; and, a mass member in contact with the resilient member, enclosing the center member; wherein, ambient motion of the apparatus at or beyond a selected threshold causes the resilient member or the mass member to contact the center member, thereby indicating the selected threshold has been met or exceeded. In one embodiment, the resilient member or the mass member contacting the center member closes an electrical circuit, whereby the accelerometer functions as an electrical switch.

### CROSS REFERENCE TO RELATED APPLICATIONS

This application claims the benefit of U.S. Provisional Patent Application No. 61,146,291, entitled “Accelerometer Switch” and filed Jan. 21, 2009, which Provisional Patent Application is incorporated herein by reference in its entirety.

### FIELD

Various embodiments relate to an accelerometer apparatus, and more particularly to such an accelerometer apparatus with a mass member enclosing a center member.

### BACKGROUND

Various accelerometers are known in the art that provide an analog or digital signal proportional to an amount of acceleration imposed on such devices. These accelerometers encompass several forms, including strain gauge, piezo-electric, capacitive, servo and semiconductor varieties. Yet in many cases, these accelerometers are highly complex, including elaborate and precision mechanical and/or electrical features, making them costly to manufacture.

### SUMMARY

In various embodiments, an accelerometer apparatus includes a center member; a resilient member enclosing the center member; and, a mass member in contact with the resilient member enclosing the center member; wherein, ambient motion of the apparatus at or beyond a selected threshold causes the resilient member or the mass member to contact the center member, thereby indicating the selected threshold has been met or exceeded. In one embodiment, the resilient member or the mass member contacting the center member closes an electrical circuit, whereby the accelerometer functions as an electrical switch.

In another embodiment, an accelerometer apparatus includes a center member; a first resilient member enclosing the center member; a second resilient member enclosing the center member; and a mass member disposed between the first resilient member and the second resilient member, at respective longitudinal ends of the first resilient member and the second resilient member, enclosing the center member; wherein, ambient motion of the apparatus at or beyond a selected threshold causes at least one of the first resilient member, the second resilient member or the mass member to contact the center member, thereby indicating the selected threshold has been met or exceeded. In one embodiment, the at least one of the first resilient member, the second resilient member or the mass member contacting the center member closes an electrical circuit, whereby the accelerometer functions as an electrical switch.

In yet another embodiment, a method of indicating ambient motion beyond a selected threshold includes enclosing a center member with one or more resilient members and a mass member, wherein ambient motion of the apparatus at or beyond a selected threshold causes the one or more resilient members or the mass member to contact the center member, thereby indicating the selected threshold has been met or exceeded. In one embodiment, the one or more resilient members or the mass member contacting the center member closes an electrical circuit, whereby the accelerometer functions as an electrical switch.

### BRIEF DESCRIPTION OF THE DRAWINGS

Further objects and advantages of the various embodiments to be described will become apparent from the following detailed description and drawings (not drawn to scale), in which:

FIG. 1A depicts a perspective view of an exemplary accelerometer apparatus 100u according to one embodiment, having a mass member 130 enclosing a resilient member 120u, which resilient member 120u is in an “unflexed” state;

FIG. 1B depicts a perspective view of an exemplary accelerometer apparatus 100f, which is suitable for functioning as accelerometer apparatus 100u of FIG. 1A, but includes a resilient member 120f in a “flexed” state;

FIG. 2A depicts a perspective view of an exemplary accelerometer apparatus 200u according to one embodiment, having a mass member 230 enclosed by a resilient member 120u, which resilient member 120u is in an “unflexed” state;

FIG. 2B depicts a perspective view of an exemplary accelerometer apparatus 200f, which is suitable for functioning as accelerometer apparatus 200u of FIG. 2A, but includes a resilient member 120f in a “flexed” state;

FIG. 3A depicts a perspective view of an exemplary accelerometer apparatus 300u according to one embodiment, having a first resilient member 322u and a second resilient member 324u, which first resilient members 322u and 324u are in an “unflexed” state;

FIG. 3B depicts a perspective view of an exemplary accelerometer apparatus 300f, which is suitable for functioning as accelerometer apparatus 300u of FIG. 3A, but includes resilient members 322u and 324f respectively in a “flexed” state;

FIG. 4A depicts a perspective view of an exemplary accelerometer apparatus 400u according to one embodiment, having a mass member 430 enclosing a resilient member 420u, which mass member 430 is disposed substantially at an end of the resilient member 420u, and which resilient member 420u is in an “unflexed” state;

FIG. 4B depicts a perspective view of an exemplary accelerometer apparatus 400f, which is suitable for functioning as accelerometer apparatus 400u of FIG. 4A, but includes a resilient member 420f in a “flexed” state;

FIG. 5A depicts a perspective view of an exemplary accelerometer apparatus 500u according to one embodiment, having a mass member 530 enclosed by a resilient member 520u, which mass member 530 is disposed substantially at an end of the resilient member 520u, which resilient member 520u is in an “unflexed” state;

FIG. 5B depicts a perspective view of an exemplary accelerometer apparatus 500f, which is suitable for functioning as accelerometer apparatus 500u of FIG. 5A, but includes a resilient member 520f in a “flexed” state;

The first digit of each reference numeral in the above figures indicates the figure in which the element or feature is most prominently shown. The second digit indicates related elements or features, and a final letter (when used) indicates a sub-portion of the element or feature. To facilitate understanding, identical reference numerals have been used where possible, to designate identical elements that are common to the figures.

### REFERENCE NUMERALS IN THE DRAWINGS

The following table lists reference numerals employed in the figures and identifies the element designated by each numeral.

TABLE
Reference Numeral Designations

| Reference Sign | Figure(s) Within | Description |
|---|---|---|
| 100u | 1A | Exemplary Accelerometer |
| | | Apparatus, Unflexed |
| 100f | 1B | Exemplary Accelerometer |
| | | Apparatus, Flexed |
| 110 | 1A, 1B, 2A, 2B | Center Member |
| 120u | 1A, 2A | Unflexed Resilient |
| | | Member |
| 120f | 1B, 2B | Flexed Resilient Member |
| 130 | 1A, 1B | Mass Member |
| 140 | 1A, 1B, 2A, 2B | First Conducting Member |
| 150 | 1A, 1B, 2A, 2B | Second Conducting |
| | | Member |
| 160 | 1A, 1B, 2A, 2B | First Nonconductive |
| | | Member |
| 170 | 1A, 1B, 2A, 2B | Second Nonconductive |
| | | Member |
| 172 | 1A, 1B, 2A, 2B | Base Member |
| 200u | 2A | Exemplary Accelerometer |
| | | Apparatus, Unflexed |
| 200f | 2B | Exemplary Accelerometer |
| | | Apparatus, Flexed |
| 230 | 2A, 2B | Mass Member |
| 300u | 3A | Exemplary Accelerometer |
| | | Apparatus, Unflexed |
| 300f | 3B | Exemplary Accelerometer |
| | | Apparatus, Flexed |
| 310 | 3A, 3B | Center Member |
| 322u | 3A | Unflexed First Resilient |
| | | Member |
| 322f | 3B | Flexed First Resilient |
| | | Member |
| 324u | 3A | Unflexed Second Resilient |
| | | Member |
| 324f | 3B | Flexed Second Resilient |
| | | Member |
| 330 | 3A, 3B | Mass Member |
| 340 | 3A, 3B | First Conducting Member |
| 350 | 3A, 3B | Second Conducting |
| | | Member |
| 360 | 3A, 3B | First Nonconductive |
| | | Member |
| 370 | 3A, 3B | Second Nonconductive |
| | | Member |
| 372 | 3A, 3B | Base Member |
| 400u | 4A | Exemplary Accelerometer |
| | | Apparatus, Unflexed |
| 400f | 4B | Exemplary Accelerometer |
| | | Apparatus, Flexed |
| 410 | 4A, 4B, | Center Member |
| 420u | 4A | Unflexed Resilient |
| | | Member |
| 420f | 4B | Flexed Resilient Member |
| 430 | 4A, 4B | Mass Member |
| 440 | 4A, 4B | First Conducting Member |
| 450 | 4A, 4B | Second Conducting |
| | | Member |
| 460 | 4A, 4B | Nonconductive Member |
| 462 | 4A, 4B | Base Member |
| 500u | 5A | Exemplary Accelerometer |
| | | Apparatus, Unflexed |
| 500f | 5B | Exemplary Accelerometer |
| | | Apparatus, Flexed |
| 510 | 5A, 5B | Center Member |
| 520u | 5A | Unflexed Resilient |
| | | Member |
| 520f | 5B | Flexed Resilient Member |
| 530 | 5A, 5B | Mass Member |
| 540 | 5A, 5B | First Conducting Member |
| 550 | 5A, 5B | Second Conducting |
| | | Member |
| 560 | 5A, 5B | Nonconductive Member |
| 562 | 5A, 5B | Base Member |

### DETAILED DESCRIPTION

Various embodiments will generally be described within the context of an apparatus that senses acceleration. But, those skilled in the art and informed by the teachings herein will realize that the basic scope is also applicable to an apparatuses that sense any type of applied force or external stimulation.

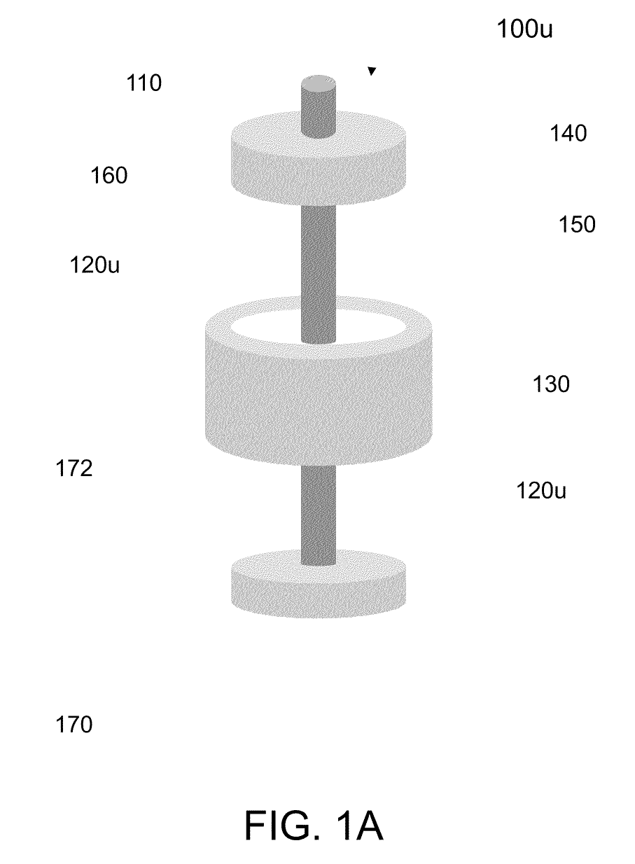

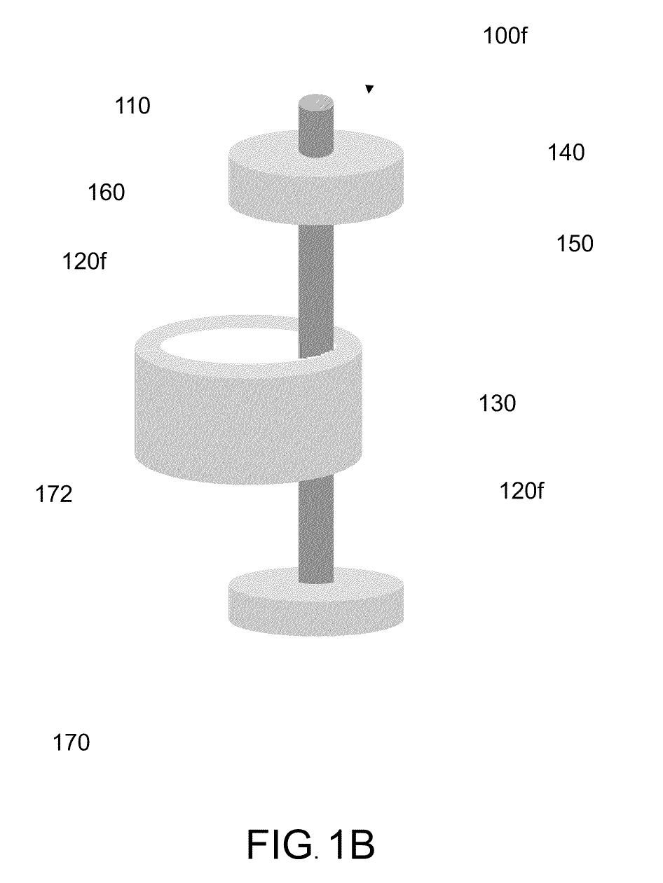

### Accelerometer Apparatus, Exemplary Embodiment (FIGS. 1A, 1B)

FIG. 1A depicts a perspective view of an exemplary accelerometer apparatus (switch) 100u, according to one embodiment. Accelerometer apparatus 100u includes a center member 110, a resilient member 120u (unflexed) enclosing the center member 110, and a mass member 130 disposed between longitudinal ends of the resilient member 120u, also enclosing the center member 110.

In various embodiments, the mass member 130 comprises a ring or sleeve assembly, disposed substantially at a central longitudinal position on the resilient member 120u. In one embodiment, the mass member 130 is secured to the resilient member 120u via compression. But, it is also contemplated that the mass member 130 may be fastened to the resilient member 120u via mechanical fastening, application of adhesive, solder, shrink tubing or any other and/or further suitable means, without departing from the basic scope.

FIG. 1A depicts the accelerometer apparatus 100u as having a resilient member 120u in an “unflexed” or “unbent” state, indicating that no external force or acceleration is being applied to the accelerometer apparatus 100u. In various embodiments, ambient motion/acceleration of an accelerometer apparatus such as accelerometer apparatus 100u at or beyond (i.e., meeting or exceeding) a selected threshold causes a resilient member or mass member (e.g., resilient member 120u or mass member 130) to contact a center member (e.g., center member 110), thereby indicating the selected threshold acceleration has been met or exceeded.

FIG. 1B depicts a perspective view of an accelerometer apparatus 100f suitable for functioning as accelerometer apparatus 100u described with respect to FIG. 1A, but with a resilient member 120f in a “flexed” condition and in contact with the center member 110, resultant from a motional acceleration of the apparatus 100f.

In one embodiment as shown with respect to FIG. 1A, the resilient member 120u comprises a spring. However, it is also contemplated that other and further resilient members may be utilized, to include any flexible medium that alters its shape, length or form responsive to an external force or acceleration, but returns to its original form after the external force or acceleration is removed, without departing from the basic scope.

An accelerometer apparatus may be calibrated according to various embodiments by adjusting the tension of a resilient member (e.g. resilient-member/spring 120) with respect to its “spring constant,” the weight of a mass member disposed thereon (e.g., mass member 130) and a desired threshold acceleration to which the accelerometer apparatus is intended to respond.

FIGS. 1A and 1B further depict mass member 130 enclosing the spring or resilient member 120u/120f, according to one embodiment. By mass member 130 enclosing the spring or resilient member 120u/120f, the accelerometer apparatus 100u may be easier to manufacture than typical accelerometers known in the art, as the difficulty of having to precisely position a mass member “inside” a spring is alleviated. Moreover, a mass member (e.g., mass member 130) on the outside of the spring permits a uniform spring to be utilized for an accelerometer apparatus, instead of a specifically designed non-uniform spring, as may be required if the mass member were to be disposed on the inside of a spring. Yet, as will be seen with respect to subsequent Figures, it is still contemplated that the mass member 130 may be placed on the inside of the resilient member 120u/120f, without departing from the basic scope.

In various embodiments, a resilient member or mass member such as resilient member 120u and/or mass member 130 contacting the center member such as center member 110 closes an electrical circuit. With respect to the exemplary accelerometer apparatus 100u/100f, closure of an electrical circuit is facilitated by way of the central rigid member 110 and the resilient member 120u/120f being comprised of a conductive material (e.g., steel, aluminum, copper, etc.).

In various embodiments, the accelerometer apparatus 100u/100f further includes a first conducting member 140 and second conducting member 150, in electrical contact with the center member 110 and resilient member 120u/120f respectively. In various embodiments, the second conducting member 150 may contact the resilient member 120u/120f at any position along its length. In one embodiment (not shown), the second conducting member 150 is positioned substantially at a longitudinal end (e.g., the top) of resilient member 120u/120f, where it will undergo the least amount of motion as resilient member 120u/120f flexes. But, it is fully contemplated that the second conducting member 150 may be positioned at any position along resilient member 120u/120f, without departing from the basic scope.

In one embodiment, (not shown) the second conducting member 150 may also contact the mass member 130. Having the second conducting member 150 contact the mass member 130 would be predicated on the mass member 130 being conductive and in electrical contact with the resilient member 120u/120f, which is also fully contemplated according to various embodiments to be discussed with respect to subsequent Figures.

In one embodiment according to the present example (FIGS. 1A and 1B), the first and/or second conducting members 140/150 comprise flexible electrical wire. The flexible wire may be affixed to the center member 110 and resilient or mass members 120u/120f and 130 respectively, by any suitable means, such as soldering, an adhesive, wire wrapping, etc. Flexible wire serving as the conducting members 140/150 permits the second conducting member 150 to move with the motion of the resilient member 120u/120f as the accelerator apparatus 100u/100f undergoes an acceleration, while making the apparatus easy to manufacture. However, it is also contemplated that other and further types of conducting members may be utilized, without departing from the basic scope. Such conducting members could include exemplary conducting members 140 and/or 150 not comprising flexible electrical wire (or wires) at all, but a rigid member and/or structure such as (for example) a conductive chassis.

Accelerometer apparatus 100u/100f further includes a first nonconductive member 160 disposed (laterally) between the center member 110 and a first longitudinal end (e.g., the “top”) of the resilient member 120u/120f. Similarly, a second nonconductive member 170 is laterally disposed between the center member 110 and a second longitudinal end (e.g., the “bottom”) of the resilient member 120u/120f. The nonconductive members 160 and 170 provide a hard mounting point or standoff for the resilient member 120u/120f, at a lateral distance away from the center member 110. Nonconductive members 160 and 170 also prevent the resilient and rigid members 120 and 110 from “shorting” out in the absence of an ambient acceleration.

In one embodiment, shown by way of example with respect to exemplary accelerometer apparatus 100u/100f depicted in FIGS. 1A-B, an accelerometer apparatus includes a base member 172. Base member 172 is attached to the second nonconductive member 170 and comprises a “plate” structure or other suitable member, expanding outward (laterally) from the accelerometer apparatus 100u/100f, to stabilize the apparatus in an upright or vertical orientation, thereby enabling it to sense acceleration in the horizontal direction. However, it is also contemplated that an accelerometer apparatus such as exemplary apparatus 100u/100f may function in any spatial orientation, including horizontal (not shown), without departing from the basic scope.

Base member 172 may be constructed of any rigid material capable of holding the accelerometer apparatus 100u/100f in a vertical position. The base member 172 may also have holes (not shown) or other attaching means for securing the accelerometer apparatus 100u/100f to a proximate structure. The second nonconductive member 170 may be secured to the base member 172 by any suitable means such as screws, adhesive, etc. or if the base member is nonconductive, be an integral part of (e.g., molded into) the base member 172.

Alternative to having a separate second nonconductive member (e.g., second nonconductive member 170) attached to or protruding outward from a base member (e.g., base member 172), the resilient member (e.g. resilient member 120u/120f0 may be mechanically fastened to, molded into, or attached directly to the base member (not shown) by any suitable means, wherein the base member is non conductive and thereby performs the same function as second non conductive member 170, without departing from a basic scope.

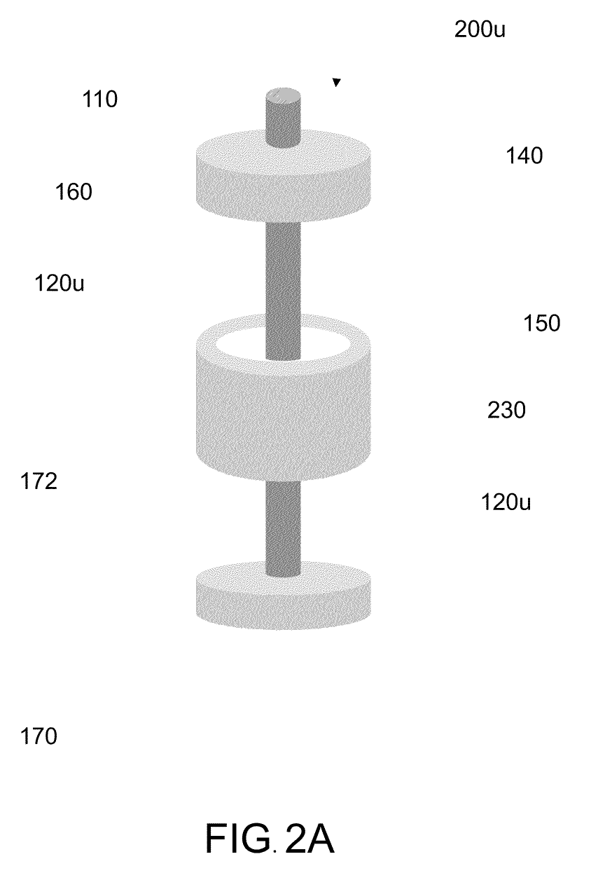

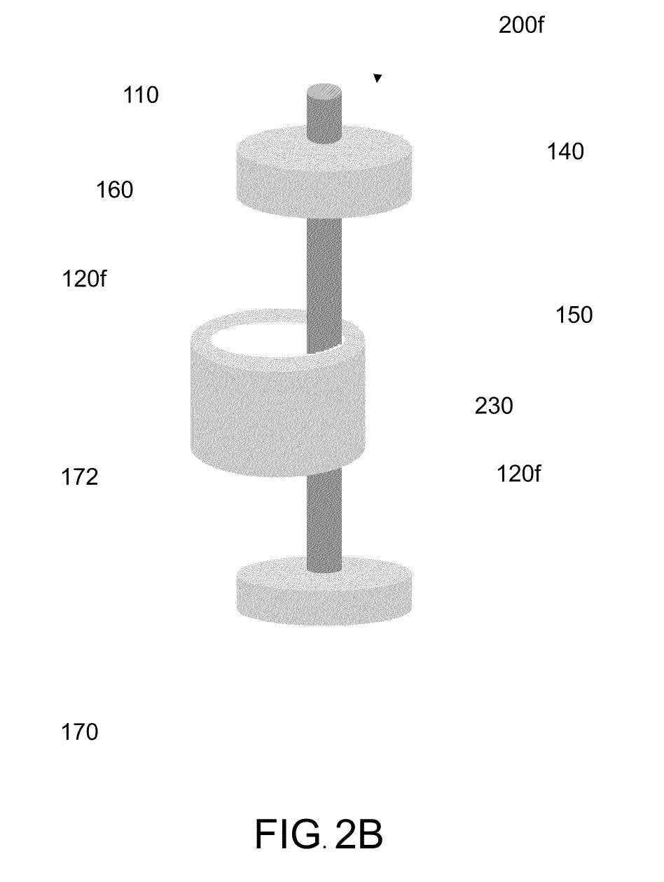

### Accelerometer Apparatus, Alternate Exemplary Embodiment (FIGS. 2A, 2B)

FIGS. 2A and 2B depict perspective views of an exemplary accelerometer apparatus 200u/200f respectively, according to one embodiment. Accelerometer apparatus 200u/200f is essentially suitable for functioning as exemplary accelerometer apparatus 100u/100f shown with respect to FIGS. 1A and 1B, incorporating essentially the same features and functionalities thereof, but with a mass member 230 enclosed by the resilient member 120u/120f.

By further contrast to exemplary accelerometer apparatus 100u/100f, second conductive member 150 is attached to mass member 230 (as opposed to resilient member 120u/120f0, to illustrate the permissibility according to various embodiments of attaching the second conductive member to either the mass member or resilient member. In embodiments where a second conductive member is attached to a mass member, the mass member is comprised of a conductive material.

As with FIG. 1A, FIG. 2A depicts an exemplary accelerometer apparatus 200u having a resilient member 120u in an “unflexed” state, wherein the apparatus 200u is subject to no ambient acceleration. FIG. 2B depicts an exemplary accelerometer apparatus 200f, suitable for functioning as the accelerometer apparatus 200u described with respect to FIG. 2A, but with the apparatus 200f subject to an ambient acceleration, such that the resilient member 120f is in a “flexed” state, as with the exemplary accelerometer apparatus 100f described with respect to FIG. 1B.

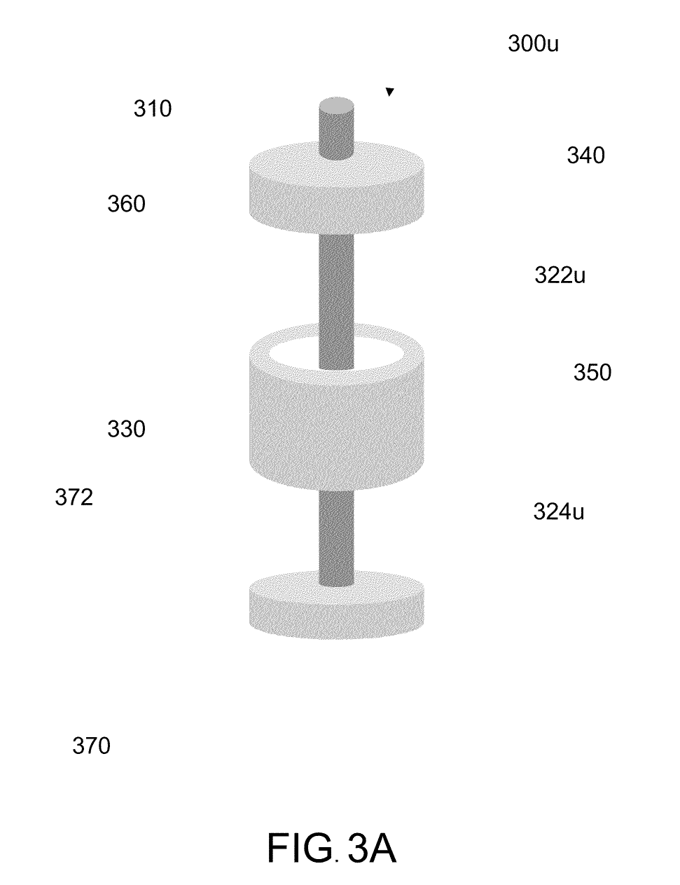

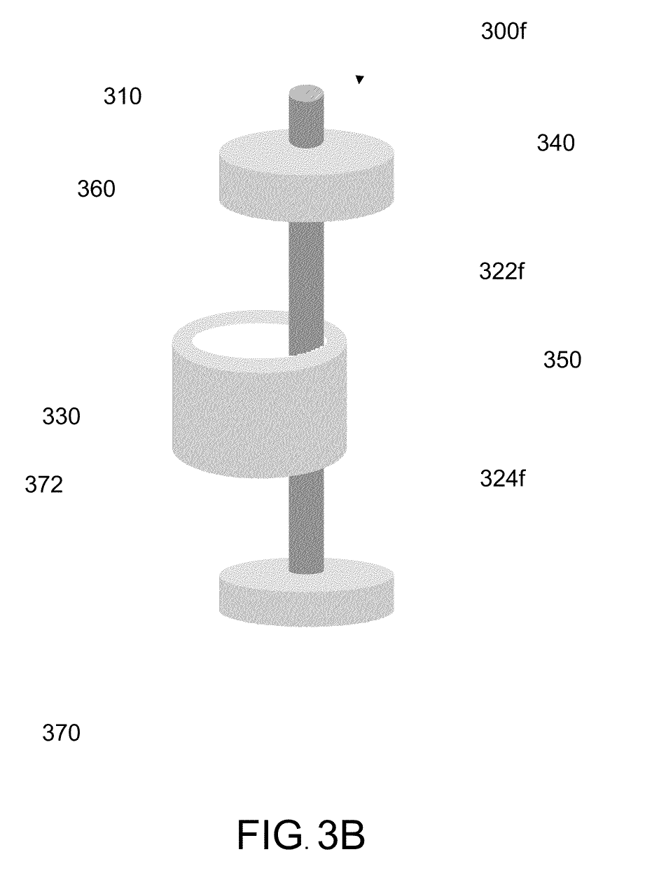

### Accelerometer Apparatus, Alternate Exemplary Embodiment (FIGS. 3A, 3B)

FIGS. 3A and 3B depict perspective views of an exemplary accelerometer apparatus 300u/300f respectively, according to one embodiment. Accelerometer apparatus 300u/300f is functionally similar to accelerometer apparatuses 100u/100f and 200u/200f described with respect to FIGS. 1A-B and 2A-B. Accelerometer apparatus 300u/300f includes a center member 310, and a mass member 330 enclosing the center member 310. But, the accelerometer apparatus 300u/300f includes both a first resilient member 322u/322f and a second resilient member 324u/324f, collectively enclosing the rigid mass member 310.

In one embodiment, the first resilient member 322u/322f and the second resilient member 324u/324f possess different respective spring constants. The different spring constants permit the acceleration response, or previously discussed “threshold” at which the acceleration apparatus/switch “closes” to be more precisely controlled. Similar to exemplary accelerometer apparatuses 100u/100f and 200u/200f, the motion of the accelerometer apparatus at or beyond a selected threshold causes either one or both of the resilient members 322u/322f and/or 324u/324f, or the a mass member 330 to contact the center member 310, thereby indicating the selected threshold has been met or exceeded.

FIG. 3A depicts an accelerometer apparatus 300u as having resilient members 322u and 324u in an “unflexed” or “unbent” state, indicating that no external force or acceleration is being applied to the accelerometer apparatus 300u. FIG. 3B depicts an accelerometer apparatus 300f that is suitable for functioning as the accelerometer apparatus 300u of FIG. 3A, but with resilient members 322f and 324f depicted in a “flexed” state, indicating that an external force or acceleration is being applied to the accelerometer apparatus 300f.

In various embodiments, as shown with respect to FIGS. 3A and 3B, a first resilient member and second resilient member (e.g., first resilient member 322u/322f and second resilient member 324u/324f0 enclose a mass member (e.g., mass member 330). However, other and further embodiments are also contemplated (not shown) where a mass member encloses the first and second resilient members.

In various embodiments, resilient members such as resilient members 322u/322f or 324u/324f, or a mass members such as mass member 330 contacting a center member such as center member 310, closes an electrical circuit. This occurs in a similar manner as that which was discussed with respect to exemplary accelerometer apparatuses 100u/100f and 200u/200f, depicted in FIGS. 1A-B and 2A-B.

In various embodiments, the accelerometer apparatus 300u/300f further includes a first conducting member 340 and second conducting member 350 in electrical contact respectively with the center member 310 and resilient members 322u/322f or 324u/324f, or mass member 330. Having the second conducting member 350 in contact with the mass member 330 would be predicated on the mass member 330 being in electrical contact with the resilient members 322/322f and 324u/324f, which is fully contemplated according to various embodiments. As with exemplary accelerometer apparatuses 100u/100f and 200u/200f, in one embodiment, the first and/or second conducting members 340/350 comprise flexible electrical wire.

Similarly, accelerometer apparatus 300u/300f further includes a first nonconductive member 360 disposed (laterally) between the center member 310 and a first longitudinal end or top of the resilient member 322u/322f, and a second nonconductive member 370 laterally disposed between the center member 310 and a second longitudinal end or bottom of resilient member 324u/324f. Accelerator apparatus 300u/300f includes a base member 372, to secure the apparatus in an upright or vertical position for sensing horizontal acceleration. But as with exemplary accelerometer apparatuses 100u/100f and 200u/200f, it is also contemplated that the exemplary accelerometer apparatus 300u/300f may function in any spatial orientation, including horizontal (not shown), without departing from the basic scope.

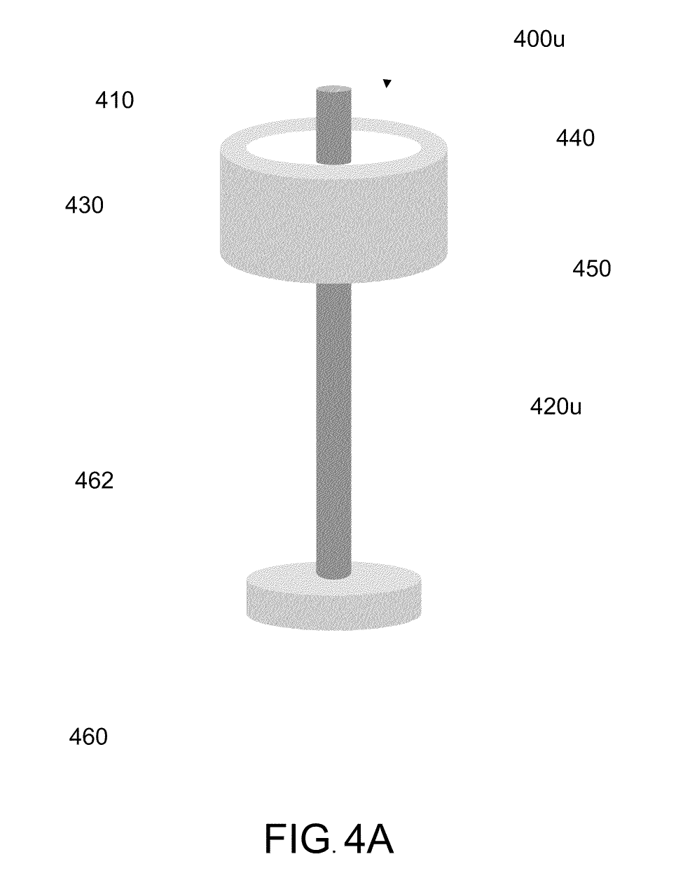

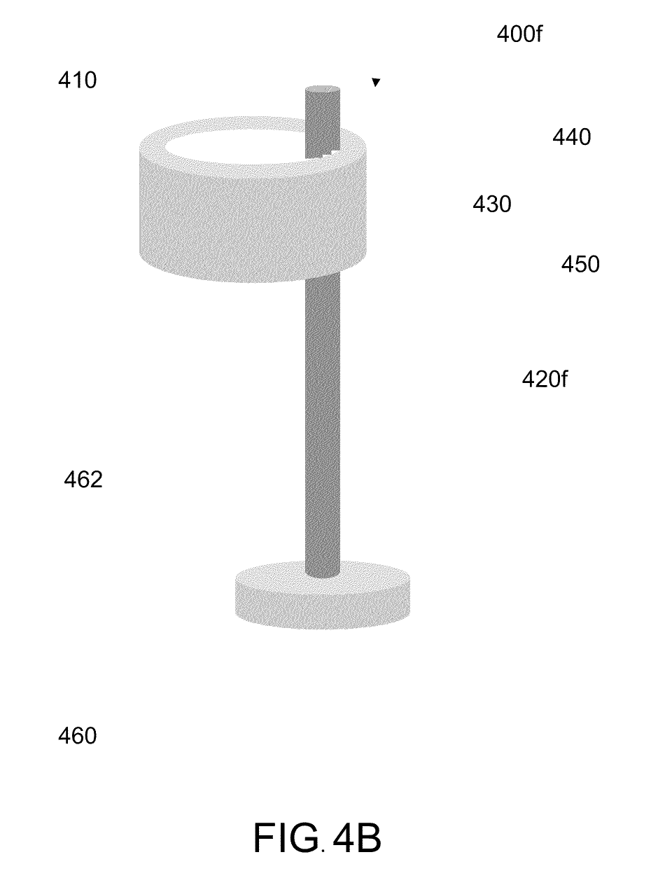

### Accelerometer Apparatus, Alternate Exemplary Embodiment (FIGS. 4A, 4B)

FIG. 4A depicts a perspective view of an exemplary accelerometer apparatus 400u according to one embodiment, having a mass member 430 disposed substantially at a longitudinal end of a resilient member 420u. By way of example, FIG. 4A depicts the resilient member 420u as being in an “unflexed” state, indicating that no acceleration is being applied to the accelerometer apparatus 400u. FIG. 4B depicts a perspective view of an exemplary accelerometer apparatus 400f according to one embodiment that is suitable for functioning as accelerometer apparatus 400u described with respect to FIG. 4A, but with a resilient member 420f in a “flexed” state, indicating that acceleration is occurring on the accelerometer apparatus 400f.

In FIGS. 4A and 4B, the mass member 430 encloses the resilient member 420u/420f. But, it is also contemplated, and will be described with respect to other embodiments, that the resilient member 420u/420f may also enclose the mass member 430, without departing from the basic scope.

Similar to exemplary accelerometer apparatus 100u/100f, accelerometer apparatus 400u/400f further includes a first conducting member 440 and second conducting member 450 in electrical contact respectively with the 410 and resilient member 420u/420f. As with exemplary accelerometer apparatuses 100u/100f, 200u/200f and 300u/300f, the first and/or second conducting members 440/450 comprise flexible electrical wire, according to one embodiment. Also as discussed with respect to exemplary accelerometer apparatuses 200u/200f and 300u/300f of FIGS. 2A, 2B, 3A and 3B, second conducting member 450 may likewise contact mass member 430 in various embodiments.

Similarly, accelerometer apparatus 400u/400f includes a nonconductive member 460 laterally disposed between the center member 410 and a second longitudinal end (opposite of the mass member 430) or bottom of the resilient member 420u/420f. In various embodiments, second conducting member 450 may contact resilient member 420u/420f at its bottom point (not shown), at or near the nonconductive member 460, where that portion of the resilient member 420u/420f remains stationary or undergoes little motion compared to its top portion, thereby limiting or eliminating the conducting member 450 from being subjected to motion.

The nonconductive member 460 includes base member 462 for the same purpose as base members 172 and 372 of exemplary accelerometer apparatuses 100u/100f, 200u/200f and 300u/300f described with respect to FIGS. 1A-B, 2A-B and 3A-B. That is, to secure the accelerometer apparatus 400u/400f in an upright or vertical position to sense horizontal acceleration. But as with exemplary accelerometer apparatuses 100u/100f, 200u/200f and 300u/300f, it is also contemplated that the exemplary accelerometer apparatus 400u/400f may function in any spatial orientation, including horizontal (not shown), without departing from the basic scope.

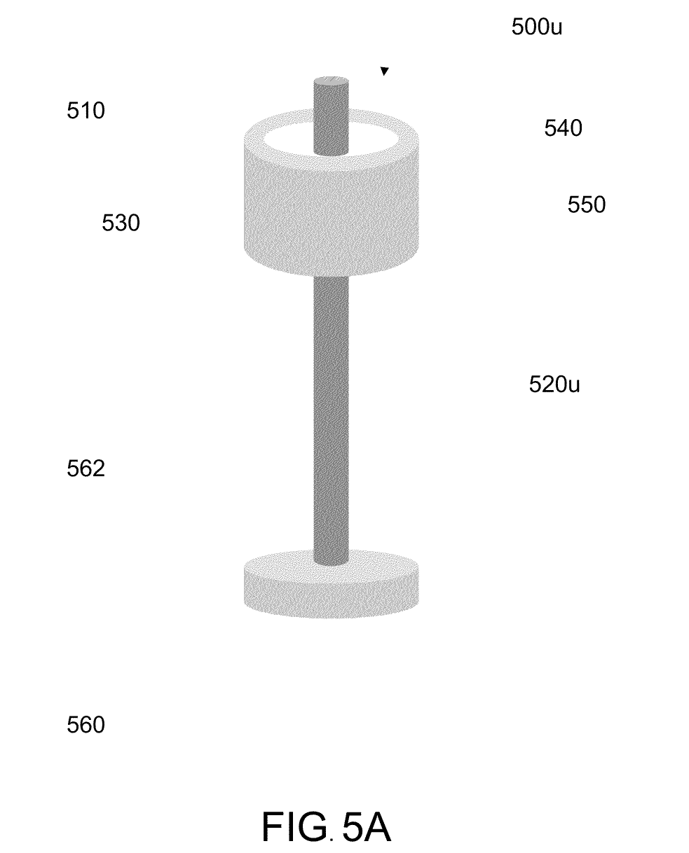

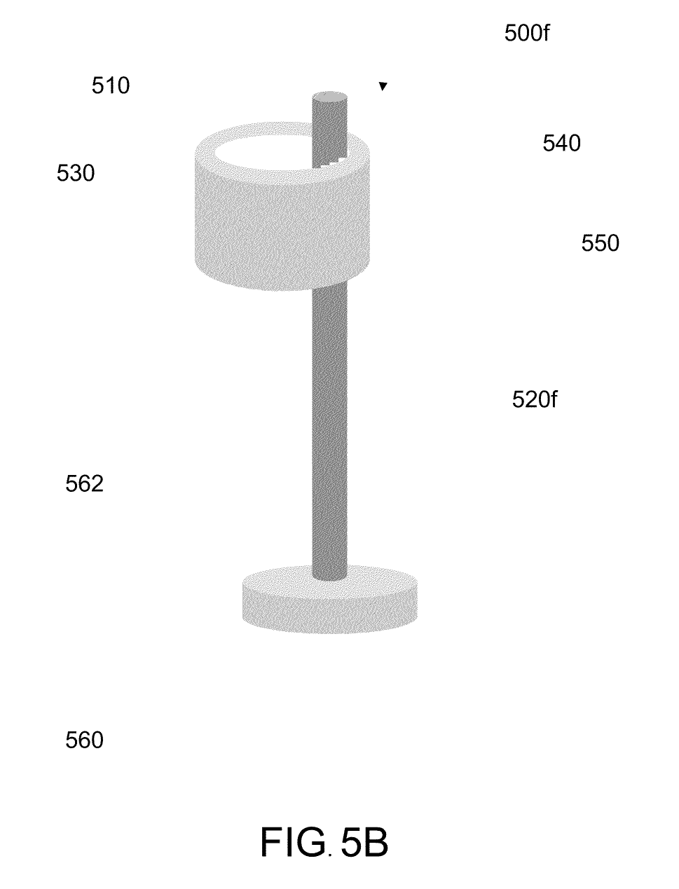

Accelerometer Apparatus, Alternate Exemplary Embodiment (FIGS. 5A, 5B)

FIG. 5A depicts a perspective view of an exemplary accelerometer apparatus 500u according to one embodiment. Accelerometer apparatus 500u is similar to the accelerometer 400u described with respect to FIG. 4A. Accelerometer 500u includes a mass member 530 disposed substantially at a longitudinal end of a resilient member 520u, which by way of example is depicted in FIG. 5A in an “unflexed” state, indicating (as with accelerometer apparatus 400u) that no acceleration is being applied to the accelerometer apparatus 500u. However, by contrast to accelerometer apparatus 400u of FIG. 4A, exemplary accelerometer 500u includes a mass member 530 that is enclosed by resilient member 520u, according to one embodiment.

FIG. 5B depicts a perspective view of an exemplary accelerometer apparatus 500f according to one embodiment that is suitable for functioning as accelerometer apparatus 500u described with respect to FIG. 5A, but with a resilient member 520f in a “flexed” state, indicating that acceleration is occurring on the accelerometer apparatus 500f. As with FIG. 5A, mass member 530 is enclosed by resilient member 520f.

Accelerometer apparatus 500u/500f further includes a first conducting member 540 and second conducting member 550 in electrical contact respectively with a center member 510 and mass member 530, according to one embodiment. But as with accelerometer apparatus 400u/400f, it is also contemplated that second conducting member 550 may similarly contact resilient member 520u/520f, without departing from the basic scope. Similar to exemplary accelerometer apparatuses 100u/100f, 200u/200f, 300u/300f and 400u/400f, the first and/or second conducting members 540/550 comprise flexible electrical wire, according to one embodiment. Yet as discussed with respect to the preceding embodiments, the first and/or second conducting members 540/550 may likewise be comprised of a rigid material, without departing from the basic scope.

Accelerometer apparatus 500u/500f includes a nonconductive member 560 laterally disposed between the center member 510 and a second longitudinal end (opposite of the mass member 530) or bottom of the resilient member 520u/520f. As with accelerometer apparatus 400u/400f, second conducting member 550 may contact resilient member 520u/520f at its bottom point (not shown), in various embodiments.

The nonconductive member 560 includes base member 562 for the same purpose as base members 172, 372 and 462 of exemplary accelerometer apparatuses 100u/100f, 200u/200f, 300u/300f and 400u/400f described with respect to FIGS. 1A-B, 2A-B, 3A-B and 4A-B. That is, to secure the accelerometer apparatus 500u/500f in an upright or vertical position to sense horizontal acceleration. But as with exemplary accelerometer apparatuses 100u/100f, 200u/200f, 300u/300f and 400u/400f, it is also contemplated that the exemplary accelerometer apparatus 500u/500f may function in any spatial orientation, including horizontal (not shown), without departing from the basic scope.

Accelerometer Apparatus, Alternate Exemplary Embodiment

Various embodiments with respect to the exemplary apparatuses described herein may also be construed as a method of indicating ambient motion beyond a selected threshold, which includes enclosing a center member (e.g., rigid member 310) with a one or more resilient members (e.g., resilient members 322u/322f and 324u/324f0 and a mass member (e.g., mass member 330), wherein, ambient motion of the apparatus at or beyond a selected threshold causes the one or more resilient members or the mass member to contact the center member, thereby indicating the selected threshold has been met or exceeded.

### CONCLUSION

It will be apparent to those skilled in the art that the objective of various embodiments have been achieved as described hereinbefore, by providing an accelerometer apparatus including a center member; a resilient member, enclosing the center member; and, a mass member in contact with the resilient member, enclosing the center member.

Various changes may be made to the structure and embodiments shown herein without departing from the general concept of the described various embodiments. Further, features of embodiments shown in various figures may be employed in combination with embodiments shown in other figures. Therefore, the scope of the invention is to be determined by the terminology in the following claims and the legal equivalents thereof.

What is claimed is:

1. An apparatus, comprising:
a center member;
a resilient member enclosing the center member; and
a mass member in contact with the resilient member enclosing the center member;
wherein, ambient motion of the apparatus at or beyond a selected threshold causes the resilient member or the mass member to contact the center member, thereby indicating the selected threshold has been met or exceeded.

2. The apparatus of claim 1, wherein the mass member encloses the resilient member.

3. The apparatus of claim 1, wherein the resilient member comprises a spring.

4. The apparatus of claim 1, wherein the resilient member or the mass member contacting the center member closes an electrical circuit.

5. The apparatus of claim 4, wherein the electrical circuit comprises:
a first conducting member in electrical contact with the center member; and
a second conducting member in electrical contact with the resilient member or the mass member.

6. The apparatus of claim 5, wherein the first conducting member comprises an electrical wire.

7. The apparatus of claim 5, wherein the second conducting member comprises electrical wire.

8. The apparatus of claim 1, further comprising a first nonconductive member, laterally disposed between the center member and a first longitudinal end of the resilient member.

9. The apparatus of claim 8, further comprising a second nonconductive member, laterally disposed between the center member and a second longitudinal end of the resilient member.

10. The apparatus of claim 1, wherein the mass member is disposed substantially at a longitudinal end of the resilient member.

11. The apparatus of claim 1, wherein the mass member is disposed between longitudinal ends of the resilient member.

12. The apparatus of claim 11, wherein the mass member is disposed substantially at a central longitudinal position on the resilient member.

13. The apparatus of claim 1, wherein the resilient member encloses the mass member.

14. The apparatus of claim 1, further comprising a base member for securing the apparatus in vertical orientation.

15. An apparatus, comprising:
a center member;
a first resilient member enclosing the center member;
a second resilient member enclosing the center member; and
a mass member disposed between the first resilient member and the second resilient member, at respective longitudinal ends of the first resilient member and the second resilient member, enclosing the center member;
wherein, ambient motion of the apparatus at or beyond a selected threshold causes at least one of the first resilient member, the second resilient member or the mass member to contact the center member, thereby indicating the selected threshold has been met or exceeded.

16. The apparatus of claim 15, wherein the mass member encloses the first resilient member and the second resilient member.

17. The apparatus of claim 15, wherein the first resilient member and the second resilient member enclose the mass member.

18. The apparatus of claim 15, wherein the first resilient member and the second resilient member comprise springs.

19. The apparatus of claim 18, wherein the first resilient member and the second resilient member possess different respective spring constants.

20. A method of indicating ambient motion beyond a selected threshold, comprising, enclosing a center member with a one or more resilient members and a mass member, wherein, ambient motion of the apparatus at or beyond a selected threshold causes the one or more resilient members or the mass member to contact the center member, thereby indicating the selected threshold has been met or exceeded.
